(19) United States
(12) Patent Application Publication
(10) Pub. No.: US 2015/0116209 A1
(43) Pub. Date: Apr. 30, 2015

(54) ELECTRONIC DEVICE AND METHOD FOR CONTROLLING BUTTONS OF ELECTRONIC DEVICE

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventors: JIAN-HUNG HUNG, New Taipei (TW); GUANG-YAO LEE, New Taipei (TW); SHAN-JIA AO, Wuhan (CN)

(21) Appl. No.: 14/527,912

(22) Filed: Oct. 30, 2014

(30) Foreign Application Priority Data
Oct. 30, 2013 (CN) 201310521040.6

(51) Int. Cl. G06F 3/01

(52) U.S. Cl. CPC G06F 3/013
USPC 345/156

(57) ABSTRACT

In a method for controlling buttons of an electronic device, a facial image of a user is captured by an image capturing unit installed in the electronic device. The method determines a button of the electronic device which corresponds to a point of focus on the electronic device, based on the facial image. When an audio signal of the user is detected by an audio collection unit installed in the electronic device, a control command is recognized from the audio signal, and a function of the button is activated to perform the required function of the electronic device based on the control command.

### CROSS-REFERENCE TO RELATED APPLICATIONS

This application claims priority to Chinese Patent Application No. 201310521040.6 filed on Oct. 30, 2013, the contents of which are incorporated by reference herein.

### FIELD

Embodiments of the present disclosure relate to button control technology, and particularly to an electronic device and a method for controlling buttons of the electronic device.

### BACKGROUND

Input of a button, either a physical button of the electronic device or a visual button displayed on a display screen of the electronic device, can be performed by pressing of the button by a finger of a user, by a stylus, or by other objects. However, functions of the button cannot be executed conveniently when the finger of the user is too large or the stylus is lost. Recognition and control of the button in these circumstances is problematic.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic device including a controlling system.

FIG. 2 is a block diagram of one embodiment of function modules of the controlling system in the electronic device in FIG. 1.

FIG. 3 illustrates a flowchart of one embodiment of a method for controlling buttons of the electronic device in FIG. 1.

FIG. 4 is a diagrammatic view of one embodiment of controlling a visual button displayed on a display screen of the electronic device in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

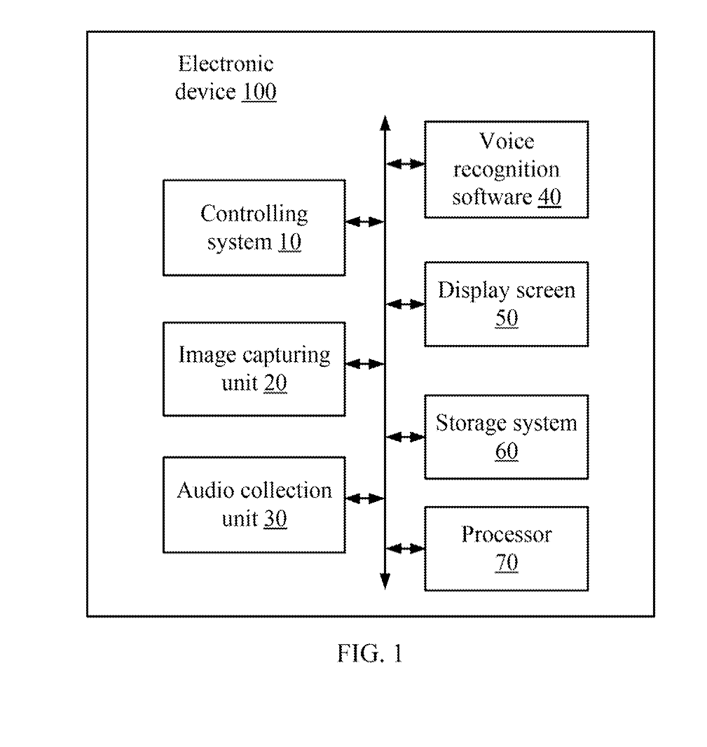

FIG. 1 illustrates a block diagram of one embodiment of an electronic device 100. Depending on the embodiment, the electronic device 100 includes a controlling system 10. In one embodiment, the electronic device 100 can be a tablet computer, a notebook computer, a personal digital assistant, a mobile phone, or any other electronic device. The electronic device 100 further includes, but is not limited to, an image capturing unit 20, an audio collection unit 30, a voice recognition software 40, a display screen 50, a storage system 60, and at least one processor 70.

The image capturing unit 20 can be, but is not limited to, a front-facing camera of the electronic device 100 for capturing facial images of a user. Each facial image can be an image of the face of the user. The audio collection unit 30 can be, but is not limited to, a microphone for detecting audio signals of the user. The audio signals can be signals representing audios inputted by the user. The voice recognition software 40 is used to recognize the audio signals detected by the audio collection unit 30, and transforms the audio signals to control commands for controlling buttons of the electronic device 100. Each button can be a physical button (e.g., a home button) located on the front surface of the electronic device 100, or can be a virtual button displayed on the display screen 50. The virtual button can be a virtual icon or a virtual switch, for example, a function button of an application software, an icon of an application software, or a button on a virtual keyboard.

In at least one embodiment, the storage system 60 can include various types of non-transitory computer-readable storage media. For example, the storage system 60 can be an internal storage system, such as a flash memory, a random access memory (RAM) for temporary storage of information, and/or a read-only memory (ROM) for permanent storage of information. The storage system 60 can also be an external storage system, such as a hard disk, a storage card, or a data storage medium. The at least one processor 70 can be a central processing unit (CPU), a microprocessor, or other data processor chip that performs functions of the electronic device 100.

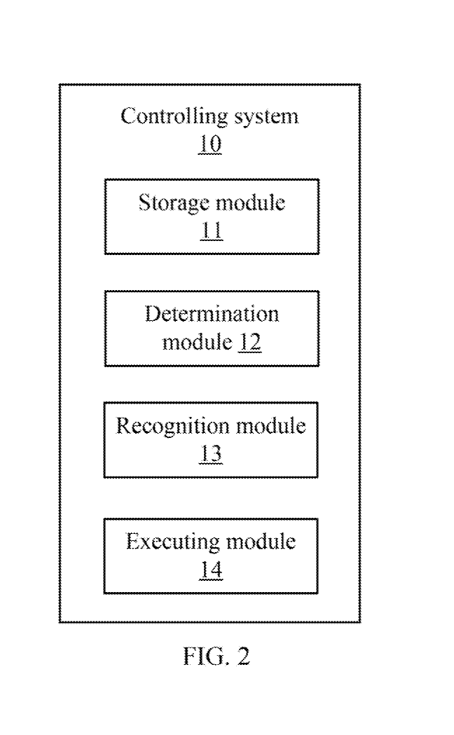

FIG. 2 is a block diagram of one embodiment of function modules of the controlling system 10. In at least one embodiment, the controlling system 10 can include a storage module 11, a determination module 12, a recognition module 13, and an executing module 14. The function modules 11-14 can include computerized code in the form of one or more programs, which are stored in the storage system 60. The at least one processor 70 executes the computerized code to provide functions of the function modules 11-14.

The storage module 11 is configured to receive a plurality of facial images captured by the image capturing unit 20 when each button of the electronic device 100 is focused on by eyes of a user, and store the facial images and a relationship between the facial images and each focused button to the storage system 60. In other embodiments, the facial images and the relationship between the facial images and each focused button can also be stored to a database connected with the electronic device 100, or be stored to a server communicating with the electronic device 100.

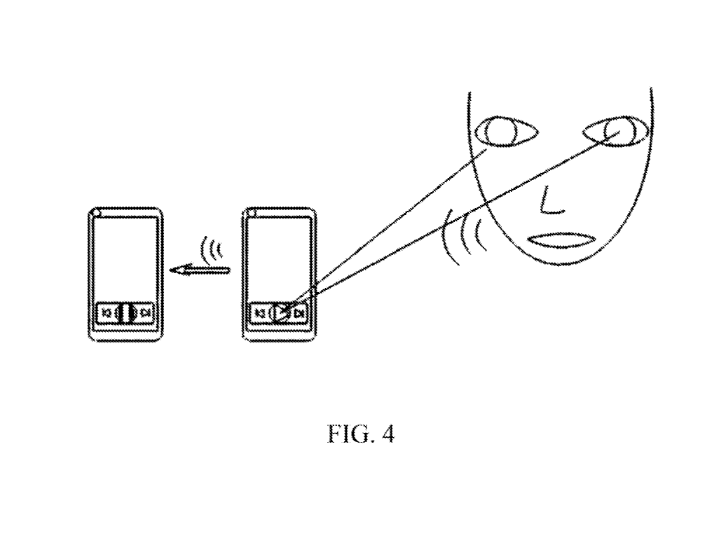

In the embodiment, the button on which the eyes focus is determined by a gaze direction of the eyes and a position of the face of the user. The position of the face can include a distance and an angle between the face and the electronic device 100. The eyeballs of a user in different positions indicate a different direction of gaze. As in the example shown in FIG. 4, the direction of gaze is the playback button of a media player displayed on the display screen 50. In the embodiment, when the position of the face is determined, the positions of the eyeballs in the facial images can be used to determine which button is being focused on by the eyes of the user.

In the embodiment, the user can adjust the position of the face to more than one position for focusing on the buttons. Once the position of the face is determined, the user adjusts the gaze direction of the eyes to focus on each button of the electronic device 100, and the storage module 11 controls the image capturing unit 20 to capture a facial image of the user once the eyes are focused on a button of the electronic device 100.

When a point of focus on the electronic device 100 is detected by electronic device 100, the determination module 12 is configured to receive a facial image of the user captured by the image capturing unit 20, and determine a button of the electronic device 100 corresponding to the point of focus on the electronic device 100 that needs to be controlled by the user based on the captured facial image.

A determination of the button of the electronic device 100 corresponding to the point of focus on the electronic device 100 is as follows. The determination module 12 compares the captured facial image with the facial images stored in the storage system 60. The determination module 12 determines whether a similarity value between the captured facial image and each facial image stored in the storage system 60 is larger than a predetermined value based on the comparison result. The similarity value can be a value that represents a degree of similarity between the captured facial image and each facial image stored in the storage system 60. The predetermined value can be determined by the user, for example, as any value between 90% and 99%. When all similarity values are smaller than the predetermined value, the determination module 12 can warn the user that no button is detected. When one or more similarity values are larger than the predetermined value, the determination module 12 detects a facial image stored in the storage system 60 that has a largest similarity value. The determination module 12 determines the button of the electronic device 100 which corresponds to the point of focus on the electronic device 100 based on the detected facial image and the relationship between the facial images stored in the storage system 60 and each focused button which is stored in the storage system 60.

In the embodiment, the image capturing unit 20 captures the facial image of the user when the point of focus on the electronic device 100 is detected by the electronic device 100. In one embodiment, the determination module 12 further determines whether the point of focus on the electronic device 100 is actually focused on by the eyes. In detail, the determination module 12 detects movements of the eyes by using the image capturing unit 20, and determines whether a predetermined movement of the eyes is detected by the image capturing unit 20. The predetermined movement can be determined by the user, for example, focusing on the point of focus on the electronic device 100 in a predetermined time interval (e.g., two seconds) or generating a predetermined action (e.g., blinking the eyes twice) on the point of focus on the electronic device 100. When the predetermined movement of the eyes is detected by the image capturing unit 20, the determination module 12 determines that the point of focus on the electronic device 100 is actually focused on by the eyes. When the predetermined movement of the eyes is not detected by the image capturing unit 20, the determination module 12 determines that the user is not paying attention to the point of focus on the electronic device 100.

In the embodiment, the determination module 12 further identifies the button in a predetermined way to prompt the user that the button is selected to be activated. The predetermined way can be, but is not limited to, magnifying the selected button in a predetermined ratio (e.g., by two) or changing a background color (e.g., from white to blue) for the selected button.

The recognition module 13 is configured to receive an audio signal from the user detected by an audio collection unit 30, and recognize a control command from the audio signal by using the voice recognition software 40. In the embodiment, the recognition module 13 presets a relationship between audio signal and the control command, and stores the relationship between the audio signal and the control command to the voice recognition software 40. In the example shown in FIG. 4, when the playback button of the media player is focused on by the eyes, a spoken “OK” by the user corresponds to a control command of “play the current media file in the media player.”

The executing module 14 is configured to execute a function of the button based on the control command. The function of the button is determined by the software corresponding to the button of the electronic device 100. In the example shown in FIG. 4, when the control command is “play the current media file in the media player”, the media player starts to play music of the electronic device 100.

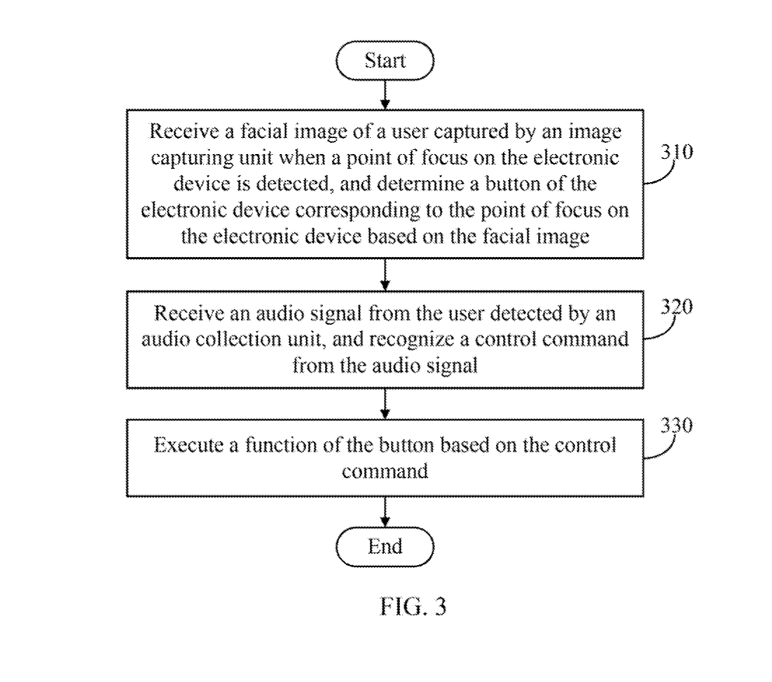

Referring to FIG. 3, a flowchart is presented in accordance with an example embodiment. The example method is provided by way of example, as there are a variety of ways to carry out the method. The method described below can be carried out using the configurations illustrated in FIG. 1 and FIG. 2, for example, and various elements of these figures are referenced in explaining example method. Each block shown in FIG. 3 represents one or more processes, methods, or subroutines, carried out in the exemplary method. Furthermore, the illustrated order of blocks is by example only and the order of the blocks can be changed. Additional blocks may be added or fewer blocks may be utilized, without departing from this disclosure. The exemplary method can begin at block 310. Depending on the embodiment, additional blocks can be added, others removed, and the ordering of the blocks can be changed.

At block 310, a determination module receives a facial image of a user captured by an image capturing unit of an electronic device when a point of focus on the electronic device is detected by the electronic device, and determines a button of the electronic device corresponding to the point of focus on the electronic device that needs to be controlled by the user, based on the captured facial image.

At block 310, the determination module further identifies the button in a predetermined way to prompt the user that the button is selected to be activated.

Before block 310, the method further comprises a storage module for receiving a plurality of facial images captured by the image capturing unit when each button of the electronic device is focused on by the eyes, and for storing the facial images and a relationship between the facial images and each focused button to a storage system of the electronic device.

At block 320, a recognition module receives an audio signal from the user detected by an audio collection unit of the electronic device, and recognizes a control command from the audio signal by using a voice recognition software of the electronic device. In the example shown in FIG. 4, when a playback button of a media player is focused on by the eyes, a spoken “OK” by the user corresponds to a control command of “play the current media file in the media player.”

At block 330, an executing module executes a function of the button based on the control command. In the example shown in FIG. 4, when the control command is found to be “play the current media file in the media player”, the media player starts to play music of the electronic device.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for controlling buttons of an electronic device, the method comprising:
receiving a facial image of a user captured by an image capturing unit installed in the electronic device;
determining a button of the electronic device corresponding to a point of focus on the electronic device based on the facial image;
receiving an audio signal from the user detected by an audio collection unit installed in the electronic device;
recognizing a control command from the audio signal; and
executing a function of the button based on the control command.

2. The method according to claim 1, further comprising:
receiving a plurality of facial images captured by the image capturing unit when each button of the electronic device is focused on by the eyes; and
storing the plurality of facial images and a relationship between the plurality of facial images and each focused button to a storage system of the electronic device.

3. The method according to claim 1, wherein the button of the electronic device corresponding to the point of focus on the electronic device is determined by:
comparing the captured facial image with facial images stored in a storage system of the electronic device;
determining whether a similarity value between the captured facial image and each facial image stored in the storage system is larger than a predetermined value based on the comparison result;
detecting a facial image stored in the storage system that having a largest similarity value when one or more similarity values are larger than the predetermined value; and
determining the button of the electronic device corresponding to the point of focus on the electronic device based on the detected facial image and a relationship between the facial images stored in the storage system and each focused button stored in the storage system.

4. The method according to claim 1, further comprising:
identifying the button in a predetermined way to prompt the user that the button is selected to be activated.

5. The method according to claim 1, wherein the image capturing unit captures the facial image of the user when the point of focus on the electronic device is detected by the electronic device.

6. The method according to claim 5, wherein the point of focus on the electronic device is detected by:
detecting movements of the eyes by using the image capturing unit; and
determining that the point of focus on the electronic device is focused on by the eyes when a predetermined movement of the eyes is detected by the image capturing unit, wherein the predetermined movement focuses on the point of focus on the electronic device in a predetermined time interval, or generates a predetermined action on the point of focus on the electronic device.

7. An electronic device for controlling buttons of the electronic device, the electronic device comprising:
an image capturing unit;
an audio collection unit;
a processor; and
a storage system that stores one or more programs, when executed by the at least one processor, cause the at least one processor to:
receive a facial image of a user captured by the image capturing unit;
determine a button of the electronic device corresponding to a point of focus on the electronic device based on the facial image;
receive an audio signal from the user detected by the audio collection unit;
recognize a control command from the audio signal; and
execute a function of the button based on the control command.

8. The electronic device according to claim 7, wherein the one or more programs further cause the at least one processor to:
receive a plurality of facial images captured by the image capturing unit when each button of the electronic device is focused on by the eyes; and
store the plurality of facial images and a relationship between the plurality of facial images and each focused button to the storage system of the electronic device.

9. The electronic device according to claim 7, wherein the button of the electronic device corresponding to the point of focus on the electronic device is determined by:
comparing the captured facial image with facial images stored in the storage system of the electronic device;
determining whether a similarity value between the captured facial image and each facial image stored in the storage system is larger than a predetermined value based on the comparison result;
detecting a facial image stored in the storage system that having a largest similarity value when one or more similarity values are larger than the predetermined value; and
determining the button of the electronic device corresponding to the point of focus on the electronic device based on the detected facial image and a relationship between the facial images stored in the storage system and each focused button stored in the storage system.

10. The electronic device according to claim 7, wherein the one or more programs further cause the at least one processor to:
identify the button in a predetermined way to prompt the user that the button is selected to be activated.

11. The electronic device according to claim 7, wherein image capturing unit captures the facial image of the user when the point of focus on the electronic device is detected by the electronic device.

12. The electronic device according to claim 11, wherein the point of focus on the electronic device is detected by:
detecting movements of the eyes by using the image capturing unit; and
determining that the point of focus on the electronic device is focused on by the eyes when a predetermined movement of the eyes is detected by the image capturing unit, wherein the predetermined movement focuses on the point of focus on the electronic device in a predetermined time interval, or generates a predetermined action on the point of focus on the electronic device.

13. A non-transitory storage medium having stored thereon instructions that, when executed by a processor of an electronic device, causes the processor to perform a method for controlling buttons of the electronic device, wherein the method comprises:
receiving a facial image of a user captured by an image capturing unit installed in the electronic device;
determining a button of the electronic device corresponding to a point of focus on the electronic device based on the facial image;
receiving an audio signal from the user detected by an audio collection unit installed in the electronic device;
recognizing a control command from the audio signal; and
executing a function of the button based on the control command.

14. The non-transitory storage medium according to claim 13, wherein the method further comprises:
receiving a plurality of facial images captured by the image capturing unit when each button of the electronic device is focused on by the eyes; and
storing the plurality of facial images and a relationship between the plurality of facial images and each focused button to a storage system of the electronic device.

15. The non-transitory storage medium according to claim 13, wherein the button of the electronic device corresponding to the point of focus on the electronic device is determined by:
comparing the captured facial image with facial images stored in a storage system of the electronic device;
determining whether a similarity value between the captured facial image and each facial image stored in the storage system is larger than a predetermined value based on the comparison result;
detecting a facial image stored in the storage system that having a largest similarity value when one or more similarity values are larger than the predetermined value; and
determining the button of the electronic device corresponding to the point of focus on the electronic device based on the detected facial image and a relationship between the facial images stored in the storage system and each focused button stored in the storage system.

16. The non-transitory storage medium according to claim 13, wherein the method further comprises:
identifying the button in a predetermined way to prompt the user that the button is selected to be activated.

17. The non-transitory storage medium according to claim 13, wherein the image capturing unit captures the facial image of the user when the point of focus on the electronic device is detected by the electronic device.

18. The non-transitory storage medium according to claim 17, wherein the point of focus on the electronic device is detected by:
detecting movements of the eyes by using the image capturing unit; and
determining that the point of focus on the electronic device is focused on by the eyes when a predetermined movement of the eyes is detected by the image capturing unit, wherein the predetermined movement focuses on the point of focus on the electronic device in a predetermined time interval, or generates a predetermined action on the point of focus on the electronic device.
